(19) United States
(12) Patent Application Publication
(10) Pub. No.: US 2009/0018672 A1
(43) Pub. Date: Jan. 15, 2009

(54) SYSTEM AND METHOD FOR MONITORING THE DATA TRAFFIC ON A FIELDBUS

(75) Inventor: Michael GIENKE, Hannover (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/169,225

(22) Filed: Jul. 8, 2008

(30) Foreign Application Priority Data
Jul. 13, 2007 (DE) 10 2007 032 715.5

(51) Int. Cl. G05B 15/00; G06F 15/16

(52) U.S. Cl. 700/1; 709/224

(57) ABSTRACT

The disclosure relates to a device and a method for monitoring the data traffic on a fieldbus of a process automation system which comprises a plurality of field devices for carrying out a process function, which field devices can be controlled via at least one higher-level control unit, with a monitoring appliance for the data traffic and for passing on information contained in the data traffic to the higher-level control unit being connected to the fieldbus. The invention proposes that the monitoring appliance continuously records quality parameters of the data traffic and communicates them directly via a data radio channel to the level of the higher-level control unit which analyzes the quality parameters of the data traffic.

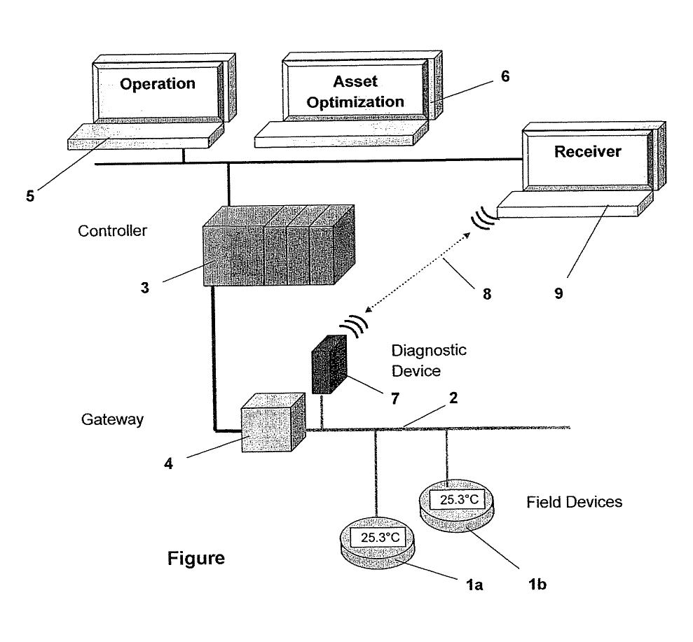

### RELATED APPLICATION

This application claims priority under 35 U.S.C. §119 to German Patent Application No. 10 2007 032 715.5 filed in Germany on Jul. 13, 2007, the entire content of which is hereby incorporated by reference in its entirety.

### TECHNICAL FIELD

The present disclosure relates to a device and a method for monitoring the data traffic on a fieldbus of a process automation system which comprises a plurality of field devices for carrying out a process function, which field devices can be controlled via at least one higher-level control unit, with a monitoring appliance for the data traffic and for passing on information contained in the data traffic to the higher-level control unit being connected to the fieldbus.

### BACKGROUND INFORMATION

The field of applicability of the present disclosure extends to process automation systems in which field devices such as filling level measurement devices, flowmeters, pressure and temperature measurement devices are used, in order to carry out process functions or to measure or to influence process variables such as a filling level, flow, pressure or temperature, respectively. Actuators such as valves which govern the flow of a liquid in a pipeline section are used to influence process variables. Field devices of the type of interest here are included in the process automation system via a fieldbus, as communication means. Suitable standardized bus protocols are, for example, HART, Profibus, Foundation Fieldbus. The individual field devices use these bus protocols to communicate with higher-level control units which are provided, inter alia, for process control, process visualization, process monitoring as well as for commissioning and for control of the field devices. In addition to the field devices of the type mentioned above which act on process parameters, field devices also exist which do not act on process variables and are used only for communication with the higher-level control units, such as remote I/O, gateways or linking devices. The communication of all these elements in the process automation system results in appropriate data traffic on the fieldbus.

DE 10 2005 063 053 A1 discloses a method and a device for monitoring the data traffic on a fieldbus in a process automation system. The regular data traffic on the fieldbus, which is used for process control, is in this case monitored by a system monitoring unit. The bus messages in the regular data traffic are checked for information which indicates a diagnosis event for one of the field devices. If a bus message is found with a diagnosis event such as this, the system monitoring unit requests further diagnostic information from the relevant field device.

The system monitoring unit in this case represents an element which is embedded in the process automation system and communicates via the fieldbus with the individual field devices and with the higher-level control unit. The so-called “gateway” function which is carried out by the system monitoring unit requires that other elements in the process automation system know the diagnostic functions and pass them on through the system by routing to the intended receiver. The configuration of the overall system to provide system monitoring functions such as these is correspondingly complex. In this case, the complexity rises as the scope of the monitoring functions increases.

For example, it is therefore desired to monitor the overall quality of the data traffic on a fieldbus. This is because, as shown in practice, problems in data interchange via a fieldbus are often directly indicated by quality parameters, such as an increasing noise level, damaged bus messages or failed data transmission attempts. Tests have shown that more than 75% of the problems that occur are related to critical quality parameters such as these.

### SUMMARY

Exemplary embodiments disclosed herein can provide a device and a method for monitoring the quality parameters of the data traffic, thus allowing reliable monitoring with little technical complexity.

A device for monitoring the data traffic on a fieldbus of a process automation system is disclosed which comprises a plurality of field devices for carrying out a process function, which field devices can be controlled via at least one higher-level control unit, with a monitoring appliance for the data traffic and for passing on information contained in the data traffic to the higher-level control unit being connected to the fieldbus, wherein the monitoring appliance continuously records quality parameters of the data traffic and communicates them directly via a data radio channel to the level of the higher-level control unit which analyzes the quality parameters of the data traffic.

A method for monitoring the data traffic on a fieldbus of a process automation system is disclosed, via which a plurality of field devices for carrying out a process function are connected, which are controlled via at least one higher-level control unit, with a monitoring appliance for the data traffic being connected to the fieldbus, and with the information contained in the data traffic being passed to the higher-level control unit, wherein the monitoring appliance continuously records quality parameters of the data traffic and communicates them directly via a data radio channel to the higher-level control unit, in which the quality parameters of the data traffic are analyzed.

In another aspect, a method is disclosed for monitoring the data traffic on a fieldbus of a process automation system, comprising: controlling a plurality of field devices for carrying out a process function via at least one higher-level control unit; monitorying data traffic using a monitoring appliance connected to the fieldbus; passing the information contained in the data traffic to the at least one higher-level control unit, wherein the monitoring appliance continuously records quality parameters of the data traffic and communicates them directly via a data radio channel to the higher-level control unit, in which the quality parameters of the data traffic are analyzed.

### BRIEF DESCRIPTION OF THE DRAWING

Further measures as improvements to the disclosure will be described in more detail in the following text together with the description of one exemplary embodiment of the disclosure, and with reference to the drawing. The single FIGURE shows a schematic illustration of a process automation system having a device for monitoring the data traffic.

### DETAILED DESCRIPTION

The disclosure includes the technical teaching that the monitoring appliance which is included in the fieldbus continuously records quality parameters of the data traffic and communicates them directly via a data radio channel to one higher-level control unit which analyzes the quality parameters of the data traffic.

The particular advantage of the solution according to the disclosure is that it can be integrated with little effort in already existing process automation systems. In principle, all that is necessary is to connect a monitoring appliance in order to read the data traffic on the fieldbus, there. A radio receiver must be connected to the higher-level control unit which evaluates the data. The data can therefore be passed directly via the radio channel to the higher-level control unit, and there is no need to take any corresponding routing measures within the process automation system.

The physical variables which can be analyzed by the monitoring appliance according to the disclosure can comprise the following physical variables: maximum noise level, number of damaged bus messages, number of failed data transmission attempts. The quality of the data traffic within the fieldbus can be assessed on the basis of these and similar physical variables, so that objective maintenance or repair work can be carried out if necessary.

A further measure as an improvement to the disclosure proposes that the monitoring appliance be supplied with the required operating voltage via the fieldbus. This avoids the need for additional power supply means, such as batteries and the like.

It is also proposed that the monitoring appliance be additionally equipped with input means for local programming and display means for local monitoring. For example, individual keys may be provided as input means, via which the monitoring appliance is started up, a self-test can be carried out, and/or initialization of the radio transmission path can be initiated. In this context, it is advantageous to use suitable display means, which in the simplest case are in the form of an LED, in order for example to visually indicate the operating status.

A further measure as an improvement to the disclosure proposes that the monitoring appliance be equipped with an additional plug connection. A portable diagnostic device can be connected to the monitoring appliance via this plug connection in order to replace its function from an external point in the event of a failure, or to read a fault protocol which is stored in the monitoring appliance.

The data radio channel between the monitoring appliance and the higher-level control unit which analyzes the quality parameters must be optimized for signal transmission quality and the required transmission power. It is proposed that this be done by using a data radio channel based on the WLAN Standard. This Standard reliably covers the normal distances which must be bridged by the radio link in a process automation system, and the hardware complexity is minimal. As an alternative to WLAN, other standardized data radio transmission protocols may be used for the data radio channel, such as Bluetooth and the like, provided that the physical constraints ensure reliable data transmission.

Another measure as an improvement to the disclosure proposes that the analysis result of the quality parameters of the data traffic be displayed for evaluation purposes in the form of a graphics display along a time axis. The analysis result produced by the higher-level control unit can therefore be presented in a clear form to the operator of the process automation system. In this case, the graphics display may be provided, for example, by means of a monitor. As an alternative to this, it is also feasible to first of all store the analysis results and then to call them up when required by the electronic control unit, for example in the form of a measurement plot.

According to the single FIGURE, the process automation system comprises a plurality of field devices 1a and 1b which in this case are in the form of temperature sensors. The field devices 1a and 1b determine the temperature of a process medium and communicate this via a fieldbus 2 to a higher-level control unit 3. A gateway 4 is provided in the communication path to the control unit 3, in order to match the system level of the field devices 1a and 1b.

The control unit 3 can be controlled from a further control unit 5, in the form of a control terminal. Furthermore, this process automation system has a third control unit 6, as a system optimization terminal.

A monitoring appliance 7 is connected to the fieldbus 2, at the level of the field devices 1a and 1b. The monitoring appliance 7 reads the data traffic on the fieldbus 2 in order to record quality parameters of the data traffic, in particular noise levels, damaged bus messages, failed data transmission attempts. This specific information is communicated directly via a data radio channel 8 to the level of the higher-level control units 3, 5 and 6, which analyze the quality parameters of the data traffic. This analysis includes comparisons in order to determine whether, for example, a predetermined maximum noise level has been reached. If yes, the non-defective information transmission on the fieldbus 2 is at risk, and fault searches as well as objective maintenance or repair measures can be initiated. If, in the example of damaged bus messages as the quality parameter, the number of damaged bus messages exceeds a predetermined limit value, then suitable measures can likewise be taken in order to rectify this situation.

In order to ensure the radio communication according to the disclosure, the level of the higher-level control units 3, 5 and 6 has a radio receiver 9 which is connected via the data radio channel 8 to a transmitter interface of the monitoring appliance 7. The fieldbus 2 provides the electrical power supply for the monitoring appliance 7 and the transmitter interface.

The disclosure is not restricted to the exemplary embodiment described above. In fact, modifications of it are also feasible. For example, it is also possible to equip the monitoring appliance 7 with further functions. For example, the monitoring appliance 7 can be programmed via local input means, and functional monitoring can be provided in situ by display means provided in addition to this, in the simplest case in the form of a plurality of LEDs.

Furthermore, the monitoring appliance 7 can also be equipped with a plug connection for connection to a portable diagnostic device, via which fault records can be read, or the function of the monitoring appliance 7 can be taken over at times by a portable diagnostic device such as this, in the event of failure.

Furthermore, the monitoring appliance 7 can be integrated in the gateway 4. This advantageously means that the number of bus subscribers on the fieldbus 2 is independent of the monitoring appliance 7 that has been added.

In a further refinement of the disclosure, the gateway 4 can be connected directly to the higher-level control units 5 and 6. In this case, the process control can be carried out in the field devices 1a and 1b.

In an alternative refinement of the disclosure, the fieldbus 2 can be connected directly to the higher-level control unit 3.

The monitoring appliance according to the disclosure with an integrated data radio function can easily be integrated in existing process automation systems without any significant system adaptations being required for this purpose.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Field device
2 Fieldbus
3 Control unit (controller)
4 Gateway
5 Control unit (control terminal)
6 Control unit (system optimization controller)
7 Monitoring appliance
8 Data radio channel
9 Radio receiver

What is claimed is:

1. A device for monitoring the data traffic on a fieldbus of a process automation system which comprises a plurality of field devices for carrying out a process function, which field devices can be controlled via at least one higher-level control unit, with a monitoring appliance for the data traffic and for passing on information contained in the data traffic to the higher-level control unit being connected to the fieldbus, wherein
the monitoring appliance continuously records quality parameters of the data traffic and communicates them directly via a data radio channel to the level of the higher-level control unit which analyzes the quality parameters of the data traffic.

2. The device as claimed in claim 1, wherein
the quality parameters represent physical variables which are chosen from a group comprising: maximum noise level, number of damaged bus messages, number of failed data transmission attempts.

3. The device as claimed in claim 1, wherein
the higher-level control unit is connected to an associated radio receiver (9), which is connected via the data radio channel to a transmitter interface of the monitoring appliance.

4. The device as claimed in claim 1, wherein
the electrical power supply for the monitoring appliance is provided via the fieldbus.

5. The device as claimed in claim 1, wherein
the fieldbus operates using a standardized bus protocol selected from a group comprising: HART, Profibus, Foundation Fieldbus.

6. The device as claimed in claim 1, wherein
the monitoring appliance is equipped with input means for local programming and with display means for local monitoring.

7. The device as claimed in claim 1, wherein
the monitoring appliance has a plug connection for connection to a portable diagnostic device.

8. The device as claimed in claim 1, wherein
the data radio channel is based on the WLAN Standard.

9. The device as claimed in claim 1, wherein
the fieldbus is connected via a gateway to a higher-level control unit and the monitoring appliance is integrated in the gateway.

10. A method for monitoring the data traffic on a fieldbus of a process automation system, via which a plurality of field devices for carrying out a process function are connected, which are controlled via at least one higher-level control unit, with a monitoring appliance for the data traffic being connected to the fieldbus, and with the information contained in the data traffic being passed to the higher-level control unit, wherein
the monitoring appliance continuously records quality parameters of the data traffic and communicates them directly via a data radio channel to the higher-level control unit, in which the quality parameters of the data traffic are analyzed.

11. The method as claimed in claim 10, wherein
the analysis result of the quality parameters of the data traffic is displayed for evaluation purposes in the form of a graphics display along a time axis.

12. A method for monitoring the data traffic on a fieldbus of a process automation system, comprising:
controlling a plurality of field devices for carrying out a process function via at least one higher-level control unit;
monitorying data traffic using a monitoring appliance connected to the fieldbus;
passing the information contained in the data traffic to the at least one higher-level control unit, wherein the monitoring appliance continuously records quality parameters of the data traffic and communicates them directly via a data radio channel to the higher-level control unit, in which the quality parameters of the data traffic are analyzed.
